(19) United States
(12) Patent Application Publication
(10) Pub. No.: US 2005/0246502 A1
(43) Pub. Date: Nov. 3, 2005

(54) Dynamic memory mapping

(75) Inventors: Rhishikesh S. Joshi, Dallas, TX (US); Jason M. Brewer, Dallas, TX (US); Sripal A. Bagadia, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/833,568

(22) Filed: Apr. 28, 2004

(51) Int. Cl. G06F 12/08

(52) U.S. Cl. 711/147; 711/202

(57) ABSTRACT

In at least some embodiments, a system comprises two processor cores, an external memory coupled to the two processor cores, and a program that is executable at least in part by one or both of the processing cores. When executed by one of the processor cores the program causes the processor core to map a private region of the external memory, which is accessible only to one of the two processor cores, to a pre-reserved region of memory addresses used by the other processor core. The mapping permits the processor core that does not have direct access to the private memory region of the other processor core to access data stored in the private region. In at least some embodiments, the mapped memory can be subsequently unmapped and re-mapped to another private memory region at run-time.

### BACKGROUND

1. Technical Field

The present subject matter relates generally to processors and more particularly to memory mapping in systems with multiple processors.

2. Background Information

Microprocessors generally include a variety of logic circuits fabricated on a single semiconductor chip. Such logic circuits typically include a central processing unit (“CPU”) core, memory, and various other components. Some microprocessors, such as processors used in wireless devices provided by Texas Instruments include more than one CPU core on the same chip. For example, some processors used in cellular phones have two processing cores. By way of example, one processing core, called the main processor unit (MPU) may process signals from a user interface (e.g., keypad) or a network interface, and perform various controlling functions, while another core, may function as a digital signal processor (DSP) and, as such, may perform multimedia processing.

In some multi-core devices, each CPU core connects to its own dedicated external memory. In other configurations both cores share a common memory. In performing a function that requires both processing cores to access the same data, the data from one core may be copied to shared memory from which the other core may access the data. This memory management scheme generally requires the system to statically reserve a region of shared memory in anticipation of future need. Because, the exact amount of memory that will become necessary is not known ahead of time, generally a larger than potentially necessary portion of memory is reserved. That is, a worst case scenario is assumed and consequently memory resources may be wasted. Additionally, each processor core may have a different range of addressable memory. For example in a two-core processing device, one processor core may have a maximum of 16 MB of addressable memory available while another processor core may have a maximum of 4 GB of addressable memory available. Accordingly, performing a function that requires both processor cores to access the same data may create difficulties, if the data from one core is more than the maximum available addressable memory for the other core. In addition, data is copied to the shared memory each time a core tries to access such data.

Reserving memory, overcoming addressable memory limitation, and copying data to shared memory for use by a core are time consuming and resource intrusive tasks. Some systems, such as battery-operated cell phones have limited space for memory. In such systems, it is generally desirable for microprocessors to require as little memory as possible and operate as fast as possible. Accordingly, any improvement in the memory usage of such processors that results in more efficient use of memory and achieves higher speed is highly desirable.

### BRIEF SUMMARY

In at least some embodiments, a system comprises two processor cores, an external memory coupled to the two processor cores, and a program that is executable at least in part by one or both processing cores. When executed by one of the processor cores, the program causes the processor core to map a private region of the external memory, which is accessible only to one of the two processor cores, to a pre-reserved region of memory addresses used by the other processor core. The mapping permits the processor core that does not have direct access to the private memory region of the other processor core to access data stored in the private region.

In accordance with other embodiments, a storage medium comprises a program which, when executed by at least one of a first or a second processor core, causes such processor to reserve a region of memory addresses of the first processor core, map a memory buffer of the second processor core to the first processor core's reserved region of memory addresses, flush the second processor core's memory buffer to an external memory, and send a message to the first processor core after the second processor core's memory buffer has been mapped to the first processor core's reserved region of memory addresses. The message sent by the second processor core contains the address of the reserved region of memory addresses.

In accordance with yet another embodiment, a computer implemented method comprises reserving a region of a first processor core's memory addresses, mapping a second processor core's memory buffer to the first processor core's reserved region of memory addresses, flushing the second processor core's memory buffer to external memory, and sending a message to the first processor after the second processor core's memory buffer has been mapped to the first processor core's reserved region of memory addresses. The message sent by the first processor core contains the address of the reserved region of memory addresses.

In accordance with yet another embodiment, a processor core comprises a memory management unit and an execution unit coupled to the memory management unit. The execution unit maps a memory buffer of the processor core to a reserved region of memory addresses of another processor core, flushes a memory buffer of the processor core to physical memory, and unmaps the processor core's memory buffer from the reserved region of memory addresses of another processor.

In accordance with yet another embodiment, a processor core comprises a memory management unit and an execution unit coupled to the memory management unit. The execution unit reserves a region of memory addresses of the processor core, sends a message to the processor core after another processor core's memory buffer has been mapped to the processor core's reserved region of memory addresses, said message containing the address of the reserved region of memory addresses, and unreserves the processor core's reserved region of memory addresses.

### Notation and Nomenclature

Certain terms are used throughout the following description and claims to refer to particular system components. As one skilled in the art will appreciate, semiconductor companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections. Additionally, the term “processor” may be used synonymously with “processor core.”

### BRIEF DESCRIPTION OF THE DRAWINGS

For a more detailed description of the preferred embodiments of the present invention, reference will now be made to the accompanying drawings, wherein:

FIG. 1 shows a diagram of a system in accordance with preferred embodiments of the invention;

FIG. 2 depicts an exemplary embodiment of the system described herein in the form of a communication device (e.g., cellular telephone);

FIG. 3 provides an exemplary method of mapping memory between two different processing cores;

FIG. 4 shows a list of application programming interface (API) functions used in accordance with a preferred embodiment of the invention;

FIG. 5 shows an exemplary free memory list used in accordance with a preferred embodiment of the invention;

FIG. 6 shows an exemplary page table in accordance with preferred embodiments of the invention; and

FIG. 7 shows an exemplary list of mapped memory address ranges in accordance with preferred embodiments of the invention.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

The following describes the construction and operation of a preferred embodiment of a multi-core processor device. The preferred embodiment disclosed herein permits efficient use of memory in a multi-processor architecture. Besides those embodiments disclosed herein, other processor architectures and embodiments may be used and thus this disclosure and the claims which follow are not limited to any particular type of processor architecture.

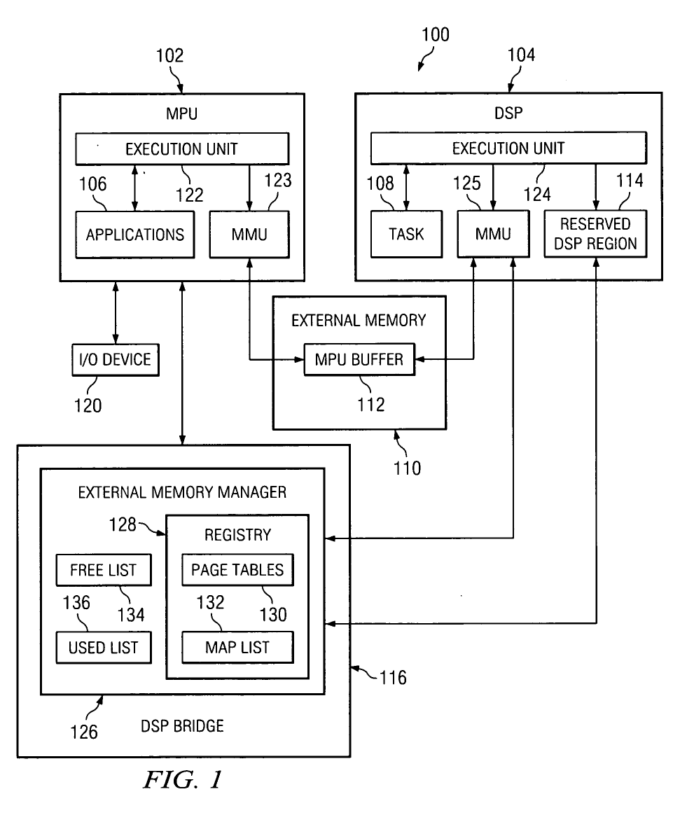

Referring now to FIG. 1, a system 100 is shown in accordance with a preferred embodiment of the invention. As shown, the system comprises two processor cores 102 and 104, although additional processor cases may be included as desired. Processor 102 is referred to for purposes of this disclosure as a main processor unit (“MPU”) and processor 104 preferably comprises a digital signal processor (“DSP”). The MPU 102 is coupled to an input/output (I/O) device 120 and manages the interaction between the I/O device 120 and the system 100. The I/O device 120 may comprise an input device (e.g., a key pad) and/or an output device (e.g., a display). Additionally, the MPU 102 may perform various other controlling functions for the system 100 as desired. The DSP 104 preferably performs various multimedia processing functions such as video and/or decoding/encoding. The MPU 102 executes one or more applications 106 and the DSP 104 executes one or more tasks 108. Both the MPU 102 and the DSP 104 contain execution units 122 and 124, respectively, that comprise logic used to execute the applications 106 and tasks 108. The execution units 122 and 124 may comprise known processor core logic, such as, fetch logic, decode logic, arithmetic logic, and the like. Both the MPU and the DSP also contain memory management units (MMU) 123 and 125, respectively. A DSP region 114 may be dynamically reserved at run-time and, as such, may not exist as part of system setup. The reserved DSP region 114 is a region of DSP addressable memory to which physical memory may be mapped.

The system 100 may also include external memory 110 coupled to both the MPU 102 and DSP 104 via the memory management units (MMU) 123, 125 to thereby make at least a portion of memory 110 accessible to both processors. At least a portion of the memory 110 may be shared by both processors meaning that both processors may access the same shared memory locations. Further, a portion of the memory 110 may be designated as private to one processor or the other. Memory that is private to one processor is accessible by that processor only and may not be directly accessed by the other processor. The MMU 125 protects the external memory 110 from illegal access and corruption of the DSP tasks 108 by generally only allowing access to the region of memory 110 that has been mapped. A portion of the memory 110 is implemented as a buffer 112. The data buffer 112 is a portion of memory 110 that is private to the MPU 104 and as such may be used exclusively by the MPU for holding, for example, multimedia data.

Additionally, system 100 includes a bridge 116. The bridge 116 preferably implements an external memory manager 126. The external memory manager 126 is generally responsible for managing the use of memory on behalf of the DSP. Accordingly, the external memory manager 126 may maintain a registry 128. The registry 128 preferably maintains a list of reserved DSP memory regions in page tables 130 and a list of mapped DSP memory regions in a map list 132. Additionally, the external memory manager 126 may also maintain a “free” list 134 and a “used” list 136. The free list 134 and the used list 136 may generally be used for managing the usage of a portion of memory 110, which is private to the DSP 104. The free list 134 generally lists a portion of DSP private memory, which is free and available for use by the DSP, while the used list preferably lists a portion of DSP private memory which is already in use.

In some embodiments, the bridge 116 may be implemented as a software program that functions to bridge the two processing cores 102 and 104. At least a portion of the bridge may be executed by one or both processors 102, 104. In some embodiments, at least a portion of the bridge 116 is executed in the MPU 102, while other portions are executed in the DSP 104. For example, the external memory manager 126 is preferably executed by the DSP 102.

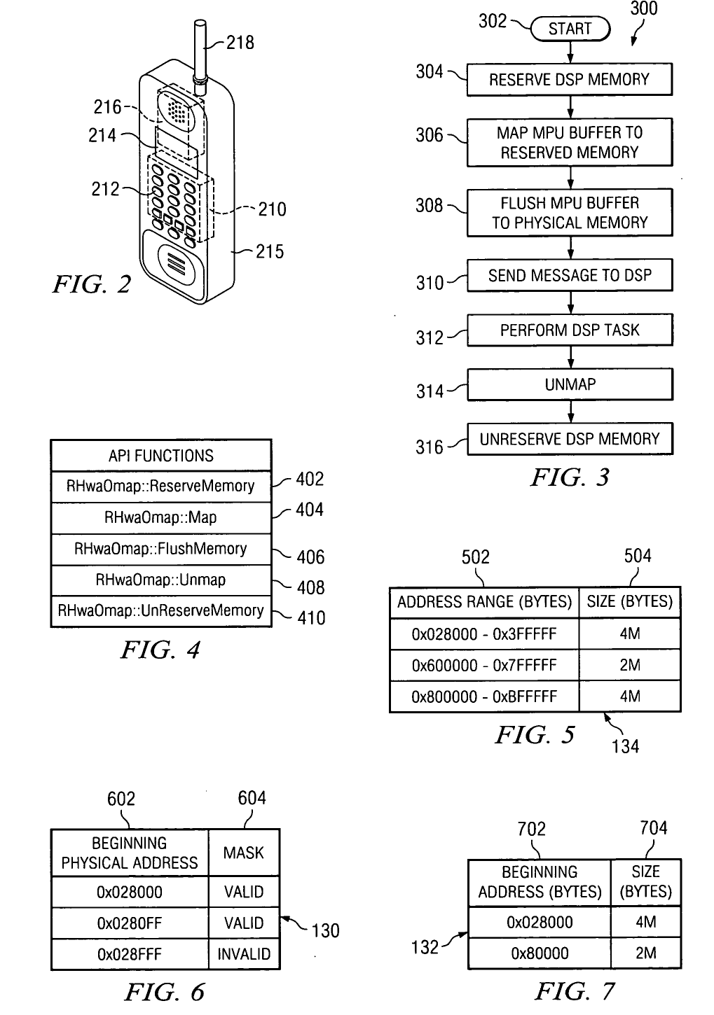

The system 100 may also include other components such as a battery and an analog transceiver to permit wireless communications with other devices. As such, while system 100 may be representative of, or adapted to, a wide variety of electronic systems, an exemplary embodiment of a system 100 may comprise a battery-operated, mobile cell phone 215 such as that shown in FIG. 2. As shown, the mobile cell phone 215 may include an integrated keypad 212 and display 214, which comprise the I/O device 120 of FIG. 1. The MPU 102 and DSP 104 noted above and other components may be included in electronics package 210. The electronic package 210 may be coupled to the key pad 212 and the display 214. The package 210 may also couple to a radio frequency (“RF”) circuit 216 which may connect to an antenna 218.

FIG. 3 provides a flow chart illustrating a preferred method 300 for performing dynamic memory mapping in system 100. When the MPU application 106 requests the DSP 104, to perform a task 108 on data in the memory buffer 112, the method 300, maps the memory buffer 112 to a specific region of memory private to the DSP 104. The method 300 begins at block 302, which may occur when a task 108 attempts to access the MPU buffer 112. The bridge 116 may, for example, inform the task 108 of a request by the MPU application 106 to process data in the MPU buffer 112. Thus, the task 108 may attempt to access the MPU buffer 112 when an MPU application 106 has data that the DSP 104 is to process. At block 304, the external memory manager 126 of the bridge 116 preferably reserves a range of memory addresses of required size in the DSP addressable space, which will comprise the reserved DSP region 114. The MPU application 106 determines the required size of DSP addressable space that is to be reserved based on the amount of data in the MPU buffer 112 that the DSP is to process. The MPU application 106 communicates the required size of DSP addressable space to the external memory manager 126, which uses an API function called ReserveMemory 402, shown in FIG. 4, to perform the task of reserving the region 114 of memory addresses. The RHwaOmap::ReserveMemory API 402 may be executed by the MPU 102. The ReserveMemory API receives the requested size of memory to be reserved for use by the DSP and causes the size to be an integer multiple of a predetermined page size. Thus, the ReserveMemory API may force the determined size to be rounded up to the next integer multiper of the page size. In a preferred embodiment of the present invention, the predetermined page size is equal to 4 KB. The predetermined page size, however, may differ in other embodiments. After determining the required size of memory, the ReserveMemory API 402 checks the free list 134 of FIG. 1 to find an unused contiguous region of the requested size. An exemplary free list 134 is illustrated in FIG. 5.

Referring now to FIG. 5, the free list 134 preferably contains a list of beginning addresses 502 and region sizes 504 of the unused DSP memory address regions. For example, as shown in FIG. 5, the address range of 0×028000-0×3FFFFF which is 4 MB in size is free and available for use. By checking the free list 134, the ReserveMemory API 402 can locate a specified size of addresses in the private DSP memory region that is free for use.

After a suitable region has been found, the ReserveMemory API 402 records the beginning address of the newly obtained region 114 in the used list 136 of FIG. 1 to show that the specific region 114 is being used for mapping. The ReserveMemory API 402 also registers the region 114 in the page tables 130. The number of page table entries (PTE's) for the page table preferably is equal to the size of the reserved region 114 divided by the page size (e.g., 4 KB). Thus, in at least some embodiments, for each 4 KB section of the memory region, there is one PTE in the page table. An exemplary page table 130 is illustrated in FIG. 6. As shown, the page table contains a list of the beginning physical addresses 602 of each 4 KB section of the reserved DSP memory region. Additionally, for each 4 KB section in table 130, there is a corresponding mask 604 that may be set to valid after the 4 KB section has been mapped. Setting the mask 604 to valid indicates that the corresponding 4 KB section has been mapped. Corresponding 4 KB sections that are not mapped are designated as invalid. The index of the page table is the offset of each 4 KB page from the beginning physical address of the reserved DSP region 114.

Referring to FIG. 3, after the required memory has been reserved, the MPU buffer 112 is mapped to the reserved memory region 114 at block 306. The procedure of mapping the MPU buffer 112 to the reserved memory addresses may be performed by an API function called RHwaOmap::Map API 404, shown in FIG. 4. The RHwaOmap::Map API 404 may be executed by the MPU 102. The RHwaOmap::Map API 404 function adds the beginning address of this newly reserved region of memory to the map list 132 of FIG. 1. An exemplary map list 132 is illustrated in FIG. 7. The map list 132 preferably contains a list of beginning addresses 702 and the particular size 704 of each DSP memory address range that is currently being used for mapping. The RHwaOmap::Map API 404 function adds an entry to the list 132 to indicate that the particular region of memory is mapped and cannot be re-used unless that memory region is unmapped. After adding an entry to the map list table 132, the RHwaOmap::Map API 404 function ensures that the size of the MPU buffer is an integer multiple of 4 KB. If the MPU buffer is not an integer multiple of 4 KB, the Map API 404 calculates an additional amount of memory that is to be mapped to accommodate for 4 KB mapping. In situations where the size of the MPU buffer extends beyond the last 4 KB page boundary, generally the additional 4 KB page containing the remainder of the MPU buffer is mapped. In cases where the MPU buffer does not start at the beginning 4 KB page boundary but at some offset from the beginning 4 KB page boundary, preferably the entire 4 KB page within which the MPU buffer starts is mapped. However, generally only the offset start-address of the MPU buffer is returned to the application.

Beginning from the first 4 KB page section of the MPU buffer 112, the physical addresses of the entire page section is mapped to corresponding DSP memory address spaces within the reserved region 114. After the physical addresses of the first 4 KB page section of the MPU buffer 112 have been mapped, the corresponding PTE in the page tables 130 is set to valid to signal that the page has been mapped. This process is repeated for the remaining 4 KB page sections of the MPU buffer 112, until the entire buffer 112 is mapped to the DSP region 114.

After the MPU buffer 112 is mapped to the reserved region 114, the contents of the buffer 112 are flushed to physical memory at block 308. Flushing the buffer 112 means that the contents are written to the external memory 110. When data is being stored in the MPU buffer 112 some data may, at times, be cached and not be stored in the shared memory region of the external memory 110. Because the data that is cached may not be accessible to the DSP 104, the tasks 108 may not be able to access such cached data. Therefore, to ensure that such cached data is not lost and the DSP 104 has access to the most recent data from the MPU 102, the MPU application 106 preferably makes a call to the RHwaOmap::FlushMemory 406 API, shown in FIG. 4. The FlushMemory API 406 preferably flushes the contents of the MPU buffer 112 into the shared memory region of the external memory 110 to which the DSP has access. In an alternative embodiment, the objectives of ensuring that cached data is not lost and the DSP 104 has access to the most recent data from the MPU 102 may be achieved by invalidating the cache. When the cache is invalidated, applications that are to access the cache will read the data from the shared memory. The data is also written to the shared memory instead of the cache, when the cache is invalidated. Although the foregoing describes flushing of the contents of MPU buffers, it is to be noted that the same flushing can also be done for DSP buffers.

After the MPU buffer 112 is successfully mapped to a pre-reserved region of the DSP, the application 106 preferably communicates the starting address of the DSP region 114 to the tasks 108 to facilitate accessing the MPU buffer by the tasks 108. A messaging feature of the bridge 116 may be used to communicate this starting address of the DSP region 114 to the tasks 108 at block 310. In at least one embodiment, the application 106 may send a message to the tasks 108 with the starting address of the reserved DSP region 114 as one of the message parameters. In another embodiment, the size of the mapped memory region may also be sent as one of the message parameters to the tasks 108. The tasks 108 can then access the MPU buffer 112 by accessing this starting address of the reserved DSP region 114.

Now that the base address to the reserved DSP region has been communicated to the DSP, the DSP can perform the tasks 108 at block 312. The tasks 108 may comprise processing data in the mapped buffer. Because the mapping information may not yet be available to the DSP MMU 125, when the tasks 108 attempt to access data in the mapped buffer, there may be instances where a translation look aside buffer (TLB) miss occurs. A TLB miss causes an interrupt in the MPU and generally occurs each time the tasks 108 attempt to access an unmapped address. When a TLB miss interrupt occurs, the Bridge 116 being executed by the MPU 102, searches the PTE's for the address causing the TLB miss. If the address causing the TLB is found in the PTE's, then the corresponding physical address is supplied to the MMU 125. The tasks 108 can then resume processing data in the mapped buffer. Otherwise, if there is no mapping information for the address causing the TLB miss in the PTE's, an MMU fault is signaled. An MMU fault generally signals that the DSP tasks 108 have attempted to access some data in the memory 110 that has not yet been mapped.

After the tasks 108 have been performed and the DSP no longer needs access to the data in the MPU buffer 112, the buffer 112 may be umapped from the DSP region 114 in block 314. The unmapping may be accomplished by invoking the RHwaOmap::Unmap API 408 function. The UnMap API 408 function preferably clears the previously mapped PTE's and the DSP memory region of any references to these mappings. In addition to unmapping the buffer 112, the reserved DSP memory region 114 may also be freed for future use. Freeing the DSP region 114 for future use may be accomplished in block 316 by calling the API function RHwaOmap::UnReserveMemory 410, shown in FIG. 4. The RHwaOmap::UnReserveMemory API 410 function may be executed by the DSP 104. In an alternative embodiment, the same reserved DSP region can be reused without being unreserved, by mapping the same reserved DSP region to another MPU buffer 112 and repeating the acts in blocks 304 through 308.

While the forgoing describes the preferred embodiment of the present invention, alternative embodiments exist. For example, the various steps of FIG. 3 are not necessarily sequential and the steps may be performed in various orders. Additionally, each step of FIG. 3 may be repeated multiple times. Moreover, in an alternative embodiment the reserved DSP region 114 may be smaller in size than the MPU buffer 112. A smaller DSP memory region may be used as a window to provide access into a larger MPU buffer, in order to conserve DSP memory address space. For example, a 256 KB DSP memory region may be reserved for mapping a 4 MB MPU buffer. To accomplish such mapping, each 256 KB segment of the MPU buffer may be mapped to the reserved DSP region one at a time. After the DSP region has been reserved, starting at the beginning address of the MPU buffer, 256 KB of the MPU buffer may be mapped to the reserved DSP region. The MPU buffer may then be flushed and a message be sent to the tasks 108 to convey that the MPU buffer is accessible. After the tasks 108 complete access to the 256 KB of the MPU buffer that had already been mapped, a message may be sent back to the MPU indicating that access is complete. The DSP region then, may be unmapped from the MPU buffer and be ready for mapping the next 256 KB segment of the MPU buffer. The next 256 KB segment of the MPU buffer may then be mapped to the reserved DSP region. The previous steps of flushing the MPU buffer, sending a message to the tasks 108, accessing of the MPU buffer by the tasks 108, sending an access completed message to the MPU, and unmapping the mapped MPU buffer may be repeated until the tasks 108 completely process all the necessary data of the MPU buffer. It is to be noted that the MPU buffer 112 segments are not limited to 256 KB in size, but the segments may be in any sizes smaller or equal to the size of the MPU buffer 112.

In another alternative embodiment, the reserved DSP region 114 may be of the same size as the MPU buffer 112, but the mapping may still be done in smaller segments. For example, a 4 MB MPU buffer may be mapped to a 4 MB reserved DSP region in segments of 256 KB. Thus, the first 256 KB of the MPU buffer may be mapped to the first 256 KB of the reserved DSP region. After the segment has been mapped, the MPU buffer may then be flushed and a message may be sent to the tasks 108 conveying that the MPU buffer is accessible. After the tasks 108 complete access to the 256 KB of the MPU buffer that had already been mapped, a message may be sent back to the MPU indicating that access is complete. The 256 KB of the MPU buffer that had already been mapped may then be umapped. Then, the next 256 KB of the MPU buffer may be mapped to the next 256 KB of the DSP reserved region. The preceding steps of flushing the MPU buffer, sending a message to the tasks 108, accessing of the MPU buffer by the tasks 108, sending an access completed message to the MPU, and unmapping the mapped segment of the MPU buffer are repeated until the tasks 108 complete accessing the entire MPU buffer. It is to be noted that the segments of MPU buffer 112 and the reserved DSP region 114 are not limited in size to 256 KB, but the segments may be in any sizes smaller or equal to the size of the entire MPU buffer 112 and DSP reserved region 114.

While the preferred embodiments of the present invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. For example, the technologies disclosed herein could cover various forms of encoding/decoding, and may also include block-based encryption/decryption. Accordingly, the scope of protection is not limited by the description set out above. Each and every claim is incorporated into the specification as an embodiment of the present invention.

1. A system, comprising:
a first processor core;
a second processor core;
external memory coupled to the first and second processor cores; and
a program that is executable at least in part by the first or the second processing core,
wherein said program causes one of the processor cores to map at least a segment of a private region of the external memory accessible by the first processor core and not by the second processor core, to at least a segment of a pre-reserved region of memory addresses used by the second processor core to permit the second processor to access data stored in the private region.

2. The system of claim 1, wherein the pre-reserved region of memory addresses used by the second processor core is smaller in size than the private region of the external memory accessible by the first processor core.

3. The system of claim 2, wherein the program causes the entire private region of the external memory accessible by the first processor core to be mapped to the smaller pre-reserved region of memory addresses by mapping segments of the private region equal in size to the pre-reserved region, unmapping the mapped segment of the private region from the pre-reserved region, and mapping the next segment of the private region to the pre-reserved region, until the entire private region has been mapped.

4. The system of claim 1, wherein said program causes the mapping of the private region of the external memory to the pre-reserved region of memory addresses to be performed in segments that are smaller in size than the size of the entire pre-reserved region of memory addresses.

5. The system of claim 4, wherein said program causes the entire private region of the external memory accessible by the first processor core to be mapped to the pre-reserved region of memory addresses by mapping a segment of the private region to a segment of the pre-reserved region equal in size to the segment of the private region, unmapping the mapped segment of the private region from the pre-reserved, and mapping the next segment of the private region to the next segment of the pre-reserved region.

6. The system of claim 1, wherein the program further causes one of the processor cores to unmap the at least a segment of a private region from the at least a segment of pre-reserved region of memory addresses used by the second processor core.

7. The system of claim 1, wherein the program unreserves the pre-reserved region of memory addresses used by the second processor core.

8. The system of claim 1, wherein the second processor core processes data produced by the first processor core and written to the private region by the first processor core.

9. The system of claim 1, wherein said program causes the second processor core to reserve a plurality of one or more segments of the second processor core's memory according to predetermined sizes as parameters.

10. The system of claim 9, wherein said program further causes one of the processor cores to ensure that the size is an integer multiple of a predetermined page size.

11. The system of claim 1, wherein said program causes one of the processor cores to map one of a plurality of one or more private regions of the external memory accessible by the first processor core and not by the second processor core, to one of a plurality of one or more pre-reserved regions of memory addresses used by the second processor core, a plurality of one or more times, to permit the second processor to access data stored in the private regions.

12. The system of claim 11, wherein said program further causes one of the processor cores to unmap a plurality of one or more of the one or more private regions from a plurality of one or more of the one or more pre-reserved regions of memory addresses used by the second processor core, a plurality of one or more times.

13. The system of claim 11, wherein said program further unreserves a plurality of one or more of the one or more pre-reserved regions of memory addresses used by the second processor core.

14. A storage medium containing a program which, when executed by at least one of a first or a second processor core, causes such processor to:
reserve a region of memory addresses of the first processor core;
map a memory buffer of the second processor core to the first processor core's reserved region of memory addresses;
flush one or more of a first processor core's memory buffer and the second processor core's memory buffer to an external memory; and
send a message to the first processor core after the second processor core's memory buffer has been mapped to the first processor core's reserved region of memory addresses, said message containing an address of the reserved region of memory addresses.

15. The storage medium of claim 14, wherein said program further causes the second processor core to unmap the memory buffer of the second processor core from the first processor core's reserved region of memory addresses.

16. The storage medium of claim 14, wherein said program further causes the first processor core to unreserve the first processor core's reserved region of memory addresses.

17. The storage medium of claim 14, wherein said program further causes at least one of the first or the second processor cores to flush one or more of a first processor core's memory buffer and the second processor core's memory buffer to an external memory by invalidating the memory cache of the first or the second processor core.

18. The storage medium of claim 14, wherein said program when executed by at least by one of a first or a second processor core, causes such processor to:
reserve a plurality of one or more regions of memory addresses of the first processor core;
map a plurality of one or more memory buffers of the second processor core to the plurality of one or more reserved regions of memory addresses of the first processor core, a plurality of one or more times;
flush one or more of a plurality of one or more of a first processor core's memory buffers and the plurality of one or more of the second processor core's memory buffers to an external memory, a plurality of one or more times; and
send a plurality of one or more messages to the first processor core after each one of the plurality of one or more memory buffers of the second processor core is mapped to one of the plurality of one or more reserved regions of memory addresses of the first processor core, said messages containing addresses of the one or more reserved regions of memory addresses.

19. A computer implemented method, comprising:
reserving a region of a first processor core's memory addresses;
mapping a second processor core's memory buffer to the first processor core's reserved region of memory addresses;
flushing the plurality of one or more of a first processor core's memory buffer and the second processor core's memory buffer to external memory; and
sending a message to the first processor after the second processor core's memory buffer has been mapped to the first processor core's reserved region of memory addresses, said message containing an address of the reserved region of memory addresses.

20. The method of claim 19, wherein the method further unmaps the memory buffer of the second processor core from the first processor core's reserved region of memory addresses.

21. The method of claim 19, wherein the method further unreserves the first processor core's reserved region of memory addresses.

22. The method of claim 19, further comprising:
reserving a plurality of one or more regions of a first processor core's memory addresses;
mapping a plurality of one or more memory buffers of the second processor core to the plurality of one or more reserved regions of memory addresses of the first processor core's, a plurality of one or more times;
flushing one or more of a plurality of one or more of a first processor core's memory buffers and the plurality of one or more of the second processor core's memory buffers to external memory, a plurality of one or more times; and
sending a plurality of one or more messages to the first processor core after each one of the plurality of one or more memory buffers of the second processor core is mapped to one of the plurality of one or more reserved regions of memory addresses of the first processor core, said messages containing addresses of the reserved regions of memory addresses.

23. A processor core, comprising:
a memory management unit; and
an execution unit coupled to the memory management unit, said execution unit maps a memory buffer of the processor core to a reserved region of memory addresses of another processor core and flushes a memory buffer of the processor core to physical memory.

24. The processor core of claim 23, wherein the execution unit further unmaps the processor core's memory buffer from the reserved region of memory addresses of another processor.

25. A processor core, comprising:
a memory management unit; and
an execution unit coupled to the memory management unit, the execution unit reserves a region of memory addresses of the processor core and sends a message to the processor core after another processor core's memory buffer has been mapped to the processor core's reserved region of memory addresses, said message containing the address of the reserved region of memory addresses.

26. The processor core of claim 25, wherein the execution unit further unreserves the processor core's reserved region of memory addresses.
